(19) United States
(12) Patent Application Publication
(10) Pub. No.: US 2016/0065638 A1
(43) Pub. Date: Mar. 3, 2016

(54) CONTROLLER AND VOICE TRANSMISSION SYSTEM USING THE SAME

(71) Applicant: REALTEK SEMICONDUCTOR CORP., HSINCHU (TW)

(72) Inventors: YONG LIU, SUZHOU (CN); WEIFENG MAO, SUZHOU (CN); CHENG CAI, SUZHOU (CN); QING GU, SUZHOU (CN); SHIMENG ZOU, SUZHOU (CN)

(21) Appl. No.: 14/732,827

(22) Filed: Jun. 8, 2015

(30) Foreign Application Priority Data
Aug. 29, 2014 (CN) 201410436892.X

(51) Int. Cl. H04L 29/06; H04W 4/00

(52) U.S. Cl. CPC H04L 65/602; H04W 4/008; H04W 84/12

(57) ABSTRACT

A voice transmission system includes at least one electronic device and a controller. The at least one electronic device is connected to an internet. The controller is connected to the at least one electronic device over a wireless local area network channel for conducting a unidirectional voice transmission. The at least one electronic device includes a first communication module and a speaker unit. The first communication module receives a first voice signal from the internet, and the speaker unit plays the first voice signal. The controller includes a voice receiving unit and a second communication module. The voice receiving unit receives a second voice signal, and the second communication module transmits the second voice signal to the first communication module of the at least one electronic device over the wireless local area network. The first communication unit further transmits the second voice signal received to the internet.

### BACKGROUND

1. Technical Field

The present disclosure relates to a voice transmission system in particular, to a voice transmission system performing a voice service using a controller.

2. Description of Related Art

In today's high demand for information society, the development of internet help incorporating information and communication technologies which enable people to easily exchange information with each other. As such, people have begun to rely heavily on computer products.

In the field of communications, though e-mails and instant messaging are very common, conventional communications, such as phone conversation is still preferable to most users. As a result, the popularity in using VoIP applications employing session initiation protocol (SIP), such as Skype, with internet telephones increased rapidly as internet telephones being capable of providing good telecommunication quality. In the present internet telephone telecommunication setting, a user typically uses a built-in microphone and a built-in speaker of a computer device for audio outputting and audio receiving functions.

A very convenient and inexpensive method for business personnel to communicate is to use VoIP applications. The utilization of the Internet not only provides instant voice services, but further can enable people in every corner of the world to communicate, which makes it much easier and cheaper for users to have long distance conversations (long-distance call or international phone calls) with VoIP applications over traditional public switched telephone networks (PSTN).

### SUMMARY

An exemplary embodiment of the present disclosure provides a voice transmission system. The voice transmissions system includes at least one electronic device and a controller. The at least one electronic device includes a first communication module and a speaker unit. The speaker unit is coupled to the first communication module. The controller includes a voice receiving unit and a second communication module. The second communication module is coupled to the voice receiving unit. The at least one electronic is configured to connect to an internet. The controller communicates with the at least one electronic device over a wireless local area network channel and conduct a unidirectional voice transmission. The first communication module is operative to receive a first voice signal from the internet. The speaker unit is configured to operatively play the first voice signal received. The voice receiving unit is configured to receive a second voice signal and the second module transmits the second voice signal to the first communication module of the at least one electronic device over the wireless local area network channel. The first communication module further transmits the second voice signal received to the internet.

An exemplary embodiment of the present disclosure provides a controller for a voice transmission system. The voice transmission system includes the controller and as at least one electronic device. The at least one electronic device includes a first communication module and a speaker unit. The speaker unit is configured to operatively play a first voice signal received by the first communication module from an internet. The controller includes a voice receiving unit and a second communication unit, wherein the second communication module is coupled to the voice receiving unit. The voice receiving unit is configured to receive a second voice signal. The second communication module is configured to transmit the second voice signal to the first communication module of the at least one electronic device over a wireless local area network channel. The controller conducts a unidirectional voice transmission with the at least one electronic device over the wireless local area network channel. The first communication module further transmits the second voice signal received to the internet.

To sum up, exemplary embodiments of the present provides a controller and a voice transmission system, which can enable a controller with unidirectional voice transmission capability to achieve bidirectional voice transmission in a use environment. Moreover, in comparison to the conventional bidirectional voice transmission device using either the Hands-Free Profile (HFP) or Handset Profile (HSP), the voice transmission system of the present disclosure can achieve the objective of bidirectional voice transmission using the Voice Over Internet Protocol (VoIP) technique accompany with the low-power Bluetooth Low Energy (BLE) technique.

In order to further understand the techniques, means and effects of the present disclosure, the following detailed descriptions and appended drawings are hereby referred to, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a schematic diagram illustrating an application of a voice transmission system provided in accordance to an exemplary embodiment of the present disclosure.

FIG. 2 is a block diagram of a controller and an electronic device provided in accordance to an exemplary embodiment of the present disclosure.

FIG. 3 is a diagram illustrating a voice transmission system provided in accordance to another exemplary embodiment of the present disclosure.

FIG. 4A and FIG. 4B are schematic diagrams respectively illustrating applications of a voice transmission system provided in accordance to another exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

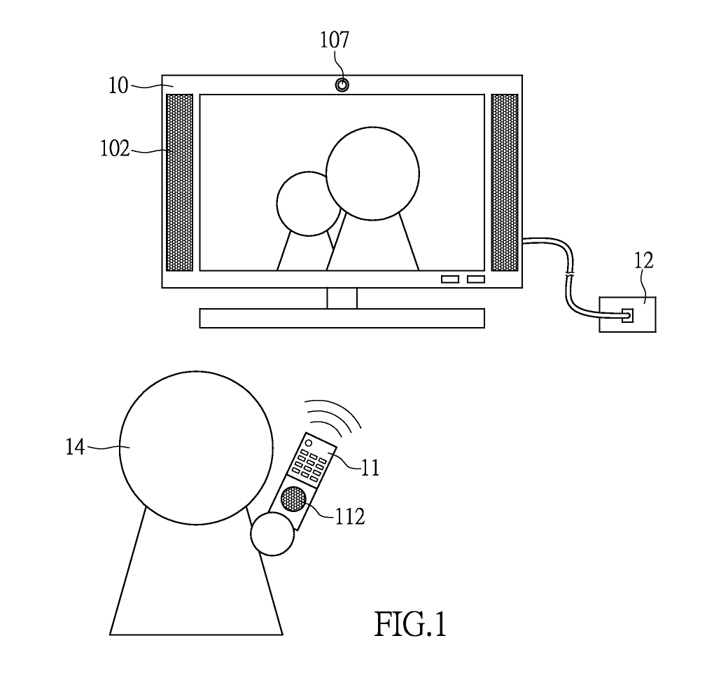

Please refer to FIG. 1, which shows a schematic diagram illustrating an application of a voice transmission system provided in accordance to an exemplary embodiment of the present disclosure. FIG. 1 illustrates a scenario of a user conducting a video call with a controller and an electronic device 10 having an image capturing module 107. In the instant embodiment, the controller 11 and the electronic device 10 are operable to perform or conduct voice signal transmissions over a wireless local area network channel in a manner such that the controller 11 serves as a voice signal input terminal while the electronic device 10 serves as a voice signal playing terminal. More specifically, a voice receiving unit 112 of the controller 11 is operable to receive a voice signal corresponding to a voice or sound produced by the user 14 and the controller 11 is operable to transmit the voice signal received to the electronic device 10 over the wireless local area network channel thereafter for the electronic device 10 to transmit or forward to another user through an internet (as the electronic device 10 is connected to the internet through an internet port 12 shown in FIG. 1). Moreover, the electronic device 10 can play the voice signal corresponding to the voice produced by another user received from the internet with a built-in speaker unit 102. As such, the voice transmission system can achieve bidirectional voice transmission simply by utilizing the unidirectional voice transmission capability of the controller 11 in cooperation with the electronic device 10.

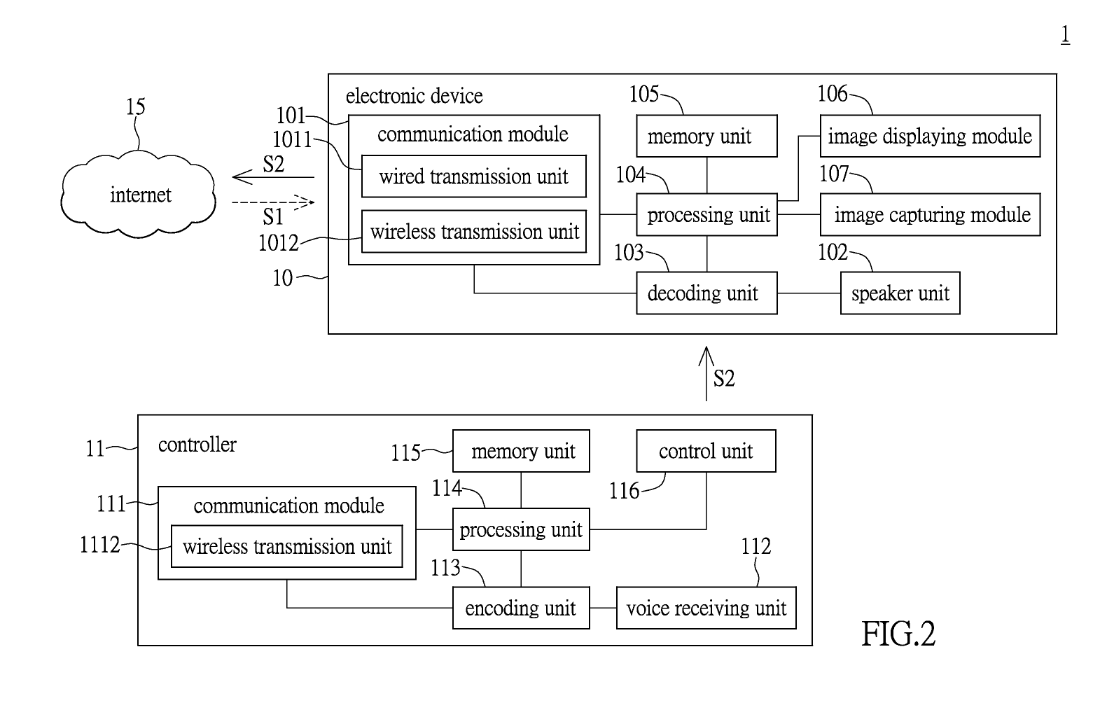

A detailed description on the architecture and the operation associated with the electronic device and the controller is provided next with reference to FIG. 2. FIG. 2 shows a block diagram of a controller and an electronic device provided in accordance to an exemplary embodiment of the present disclosure. In the instant embodiment, a voice transmission system 1 includes an electronic device 10 and a controller 11. The controller 11 communicates with the electronic device 10 over a wireless local area network channel. The electronic device 10 further communicates with a remote electronic device (not shown) through an internet 15.

The electronic device 10 includes a communication module 101, a speaker unit 102, a decoding unit 103, a processing unit 104, a memory unit 105, an image displaying module 106, and an image capturing unit 107. The communication module 101 comprises a wired transmission unit 1011 and a wireless transmission unit 1012. The speaker unit 102 is coupled to the communication module 101. The decoding unit 103 is coupled between the communication module 101 and the speaker unit 102. The processing unit 104 is coupled to the communication module 101, the memory unit 105, the image displaying module 106, and the image capturing module 107, respectively.

The controller 11 includes a communication module 111, a voice receiving unit 112, an encoding unit 113, a processing unit 114, a memory unit 115, and a control unit 116. The communication module 111 comprises a wireless transmission unit 1112. The voice receiving unit 112 is coupled to the communication module 111. The encoding unit 113 is coupled between the communication module 111 and the voice receiving unit 112. The processing unit 114 is coupled to the communication module 111, the memory unit 115, and the control unit 116, respectively.

In the instant embodiment, the electronic device 10 is a voice output device having the image displaying module 106 and can include but not limit to a television, a projector, and a computer. In another embodiment, the electronic device 10 may also be a voice output device without having the image display module 106 or the image capturing module 107. That is, the present disclosure does not limit the exact type and exact implementation associated with the electronic device 10.

The communication module 101 of the electronic device 10 is operative to receive a data signal (e.g., an image signal or a voice signal S1) from the internet 15 and a voice signal S2 or a control signal sent by the controller 11 linked with the electronic device 10 in the voice transmission system 1 via the wireless local area network channel. The communication module 101 further is operable to transmit the voice signal S2 received from the controller 11 to the internet 15. In the instant embodiment, the communication module 101 is operable to connect to the internet via the wired transmission unit 1011 or the wireless commination unit 1012. For example, the electronic device 10 of FIG. 1 is configured to connect to the internet 15 in a wired manner, i.e., by connecting to the internet port 12 with a network cable (e.g., an Ethernet cable). However, the present disclosure does not limit the connection method used by the electronic device 10 for connecting to the internet 15.

It is worth to note that the electronic device 10 is configured to transmit the second voice signal S2 received from the controller 11 and to receive the voice signal S1, which is to be played thereon, externally from the internet 15 using a packet format conforming to a Voice-over-IP Protocol (VoIP). The wireless local area network channel used for the communication between the electronic device 10 and the controller 11 herein is a Bluetooth channel, particularly, the controller 11 conducts a unidirectional voice transmission (e.g., the data packet includes only the voice signal S2 produced by the user) and communicates with the electronic device using the Bluetooth Low Energy (BLE) Protocol. In other words, the wireless transmission unit 1012 of the electronic device 10 is used to conduct the wireless transmission with the wireless transmission unit 1112 of the controller using the Bluetooth technology. However, it should be understood by those skilled in the art that the wireless local area network channel used for the communication between the electronic device 10 and the controller 11 may also be a wireless fidelity channel or any other equivalent wireless transmission means, thus the wireless local area network channel used for the communication between the electronic device 10 and the controller 11 is not limited to the Bluetooth channel described herein.

The speaker unit 102 can comprise of necessary circuitries, necessary logics or necessary codes for operatively playing the voice signal S1, which is to be played by the electronic device 10, received from the internet 15. The speaker unit 102 is a transducer for converting an electrical audio signal to a corresponding sound. More specifically, the speaker unit 102 at least comprises of an electromagnet, a coil, and a speaker vibration module (not shown). The speaker 102 is operative to produce voice sound according to the voice signal S1.

The decoding unit 103 can comprise of necessary circuitries, necessary logics, or necessary codes for operatively decoding the voice signal S1, which is to be played by the electronic device 10 and is received from the internet 15. The decoding unit 103 further forwards the voice signal S1 decoded to the speaker unit 102 for playback operation. More specifically, the decoding unit 103 is capable of decoding the voice signal S1 received to generate a corresponding digital signal, converting the digital signal decoded to an analog signal with a built-in digital-to-analog converter, and forwarding the analog signal converted to the speaker unit 102 with audio amplifier for playback operation.

The processing unit 104 functions as the computation core of the electronic device 10 and comprises of necessary circuitries, necessary logics, or necessary codes for processing signals, information and/or data instructions. The processing unit 104 can be a central processing unit (CPU), a micro-controller unit (MCU) or any other electronic component capable of performing computations. More superficially, the processing unit 104 is configured to control the decoding unit 103 to decode the voice signal S1 received by the communication module 101 from the internet 15 for the playback operation performed by the electronic device 10, and to control the operations of the image displaying module 106 and the image capturing module 107 according to an operation instruction. The processing unit 104 further is operative to access the data stored in the memory unit 105.

The memory unit 105 comprises of necessary circuitries, necessary logics, or necessary codes for storing temporary data (e.g., image signals, voice signals, operating instructions and/or application programs) required by the processing unit 104 during the computation operation and an identification code associated with the electronic device 10. The identification code herein is provided to the controller 11 for identifying the electronic device 10. In the instant embodiment, the memory unit 105 is implemented by a hard disk, however, in other embodiments the memory unit 105 may be also implemented by a storage medium including but not limited to a memory card and a flash drive. Therefore, the present disclosure does not limit the exact type associated with the memory unit 105.

The image displaying module 106 can comprise of necessary circuitries, necessary logics, or necessary codes for outputting an image signal. In the instant embodiment, the image displaying module 106 is implemented by a liquid crystal display, however, the present disclosure is no limited thereto. Specifically, the processing unit 104 of the electronic device 10 operatively drives the image displaying module 106 to output the image signal upon receiving the operation instruction transmitted from the controller 11.

The image capturing unit 107 can comprise of necessary circuitries, necessary logics, or necessary codes for generating and providing image data to the electronic device 10 during the image capturing operation. The image capturing unit 107 of instant embodiment can be a camera. Taking the scenario described by FIG. 1 as an example, the user in the instant embodiment can perform video call with another user at a remote end with the image display module 106, the image capturing unit 107, the controller 11, and the speaker unit 102.

Details on the components of the controller 11 will continue to be described below. In the instant embodiment, the controller 11 is a control device capable of performing remote control using wireless transmission including but not limited to a remote control, a presenter, or a wireless mouse.

The communication module 111 of the controller 11 is configured to transmit the voice signal S2 or the control signal to the electronic device 10 over the wireless local area network channel and to further transmit the voice signal S2 to the internet 15 through the communication module 101 of the electronic device 10. It is worth to note that the electronic device 10 as described communicates with the controller 11 over the wireless transmission channel (i.e., the wireless local area network channel). In other words, the controller 11 is communicating with the electronic device 10 wirelessly using the wireless transmission unit 1112 of the communication module 111.

The voice receiving unit 112 can comprise of necessary circuitries, necessary logics, or necessary codes for receiving and forwarding the physical sound wave produced by the user in a form of electrical signal to the encoding unit 113. In the instant embodiment, the voice receiving unit 112 is a transducer for converting physical sound waves into electrical signals including but not limited to a Dynamic Microphone, a Condenser Microphone, and a MEMS Microphone.

The encoding unit 113 can comprise of necessary circuitries, necessary logics, or necessary codes for operatively encoding the electrical signal outputted by the voice receiving unit 112 responsive to the physical sound wave received to generate the voice signal S2. The communication module 111 further transmits the voice signal S2 to the electronic device 10. More specifically, the encoding unit 113 is capable of converting the analog signal converted from the physical sound wave into a corresponding digital signal with a built-in analog-to-digital converter, encoding the digital signal converted to generate the voice signal S2, and wirelessly transmitting the voice signal S2 encoded using the communication module 111.

The processing unit 114 functions as the computation core of the controller 11 and comprises of necessary circuitries, necessary logics, or necessary codes for processing signals, information and/or data instructions. The processing unit 114 can be a central processing unit (CPU), a micro-controller unit (MCU) or any other electronic component capable of performing computations. More specifically, the processing unit 114 is configured to control the encoding unit 113 to encode the electrical signal generated and outputted by the voice receiving unit 112 in response to the physical sound wave received so as to generate the voice signal S2, to correspondingly generate the operating instruction for controlling the operation of electrical device 10 according to the control signal outputted by the control unit 116, and to access data stored in the memory unit 115. In one embodiment, the processing unit 114 generates the operating instruction corresponding to the control signal outputted by the control unit 116 based on the lookup table stored in the memory unit 115.

The memory unit 115 comprises of necessary circuitries, necessary logics, or necessary codes for storing temporary data (e.g., voice signals, operating instructions and/or application programs) required by the processing unit 114 during the computation operation, the identification code associated with the currently-connected electronic device 10 or the electronic device 10 that has been historically-connected to as well as the lookup table for the processing unit 114 to access and read therefrom. In the instant embodiment, the memory unit 115 is implemented by a random access memory (RAM). However, it shall be noted that the present disclosure does not limit the exact type and the exact implementation associated with the memory unit 115.

The control unit 116 is configured to generate control signal responsive to user's operation and output the control signal to the processing unit 114 for the generation of the operating instruction. In the instant embodiment, the control unit 116 can be implemented by multiple mechanical buttons. In another embodiment, the control unit 16 can be implemented in a form of touch panel. However, the present disclosure is not limited thereto.

Based on the above explanations, the voice transmissions system 1 provided by the present disclosure can through utilizing a controller 11 of unidirectional voice transmission in cooperation with the electronic device 10 establishing a bidirectional voice transmission in a use environment. The following continue to further explain the application of the voice transmission system provided by the present disclosure.

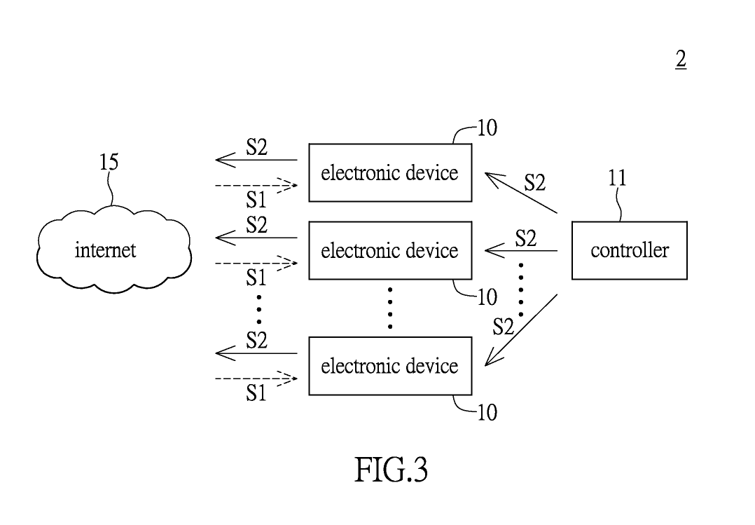

Please refer to FIG. 3, which shows a diagram illustrating a voice transmission system provided in accordance to another exemplary embodiment of the present disclosure. The voice transmission system 2 includes a plurality of electronic devices 10 and a controller 11. The internal components associated with the electronic device 10 and the controller 11 in the voice transmission system 2 of FIG. 3 are essentially the same as those described above for the electronic device 10 and the controller 11 in the voice transmission system 1 of FIG. 2, hence further descriptions are hereby omitted.

In the instant embodiment, the controller 11 is operable to select different electronic devices 10 to connect or link to through the control unit 116. The controller 11 is further operable to determine and automatically switch to connect the nearest electronic device 10 based on the location of the user. The controller 11 of the present disclosure can automatically connect to one of the electronic devices 10 to connect based on the identification codes and related information associated with the currently-connected electronic device 10 or the electronic device 10 that has been historically-connected to being stored in the memory unit 115, wherein the communication module 111 is operative to search and detect electronic devices nearby the controller 11 to initiate the switching function.

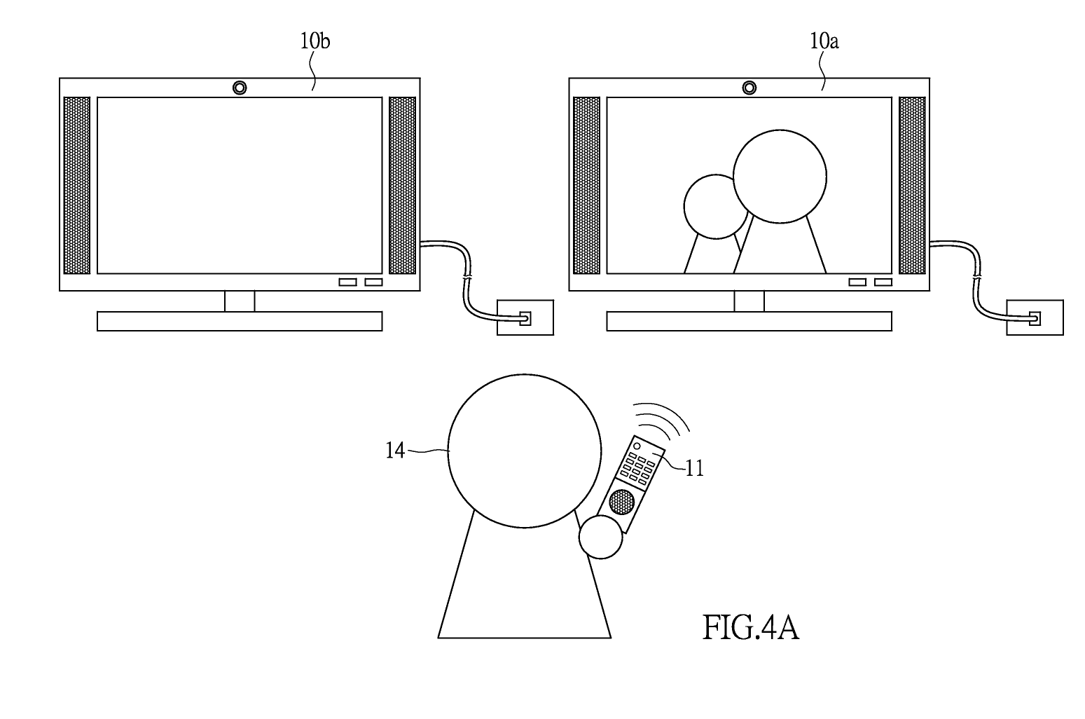

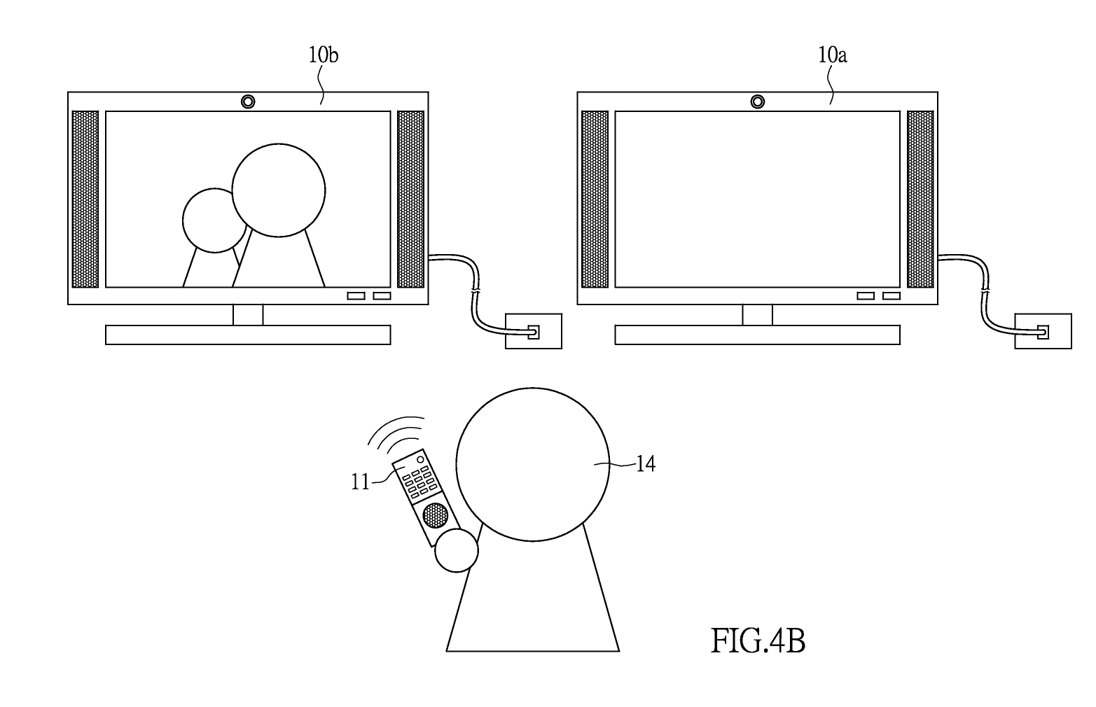

Please refer to FIG. 4A and FIG. 4B, which are schematic diagrams respectively illustrating applications of a voice transmission system provided in accordance to another exemplary embodiment of the present disclosure. For instance, FIG. 4A and FIG. 4B depicts electronic devices in different place, particularly, an electronic device 10a in a first conference room and an electronic device 10b in a second conference room. Initially, a user 14 operates the controller 11 (e.g., a presenter) and conduct a video conference with the electronic device 10a in the first conference room. When either the meeting held in the first conference room has ended or the user 14 have to move to the second conference room during the meeting, the controller 11 operated by the user 14 will automatically connect the electronic device 10b in the second conference room and continue with the video conference. As shown in FIG. 4B, the screen originally shown on the electronic device 10a of the first conference room can be switched to the electronic device 10b of the second conference room, and the voice transmission is also switched connection from between the controller 11 and the electronic device 10a to between the controller 11 and the electronic device 10b. The controller 11 of the present disclosure thus can effective provide the user 14 with the flexibility to operate different use environment.

In summary, the voice transmission system provided by the present disclosure can use a controller with unidirectional voice transmission capability and achieve bidirectional voice transmission in a use environment. More specifically, the controller of the present disclosure not only has a remote control functionality but also able to provide voice transmission functionally. In comparison to the conventional Hands-Free or Handset mode bidirectional voice transmission device using Bluetooth transmission technology, the voice transmission system of the present disclosure can achieve the objective of bidirectional voice transmission utilizing the low-power Bluetooth Low Energy (BLE) technique accompany with unidirectional voice transmission technique.

Additionally, the user can continuously perform a bidirectional voice transmission operation among different electronic devices while using the controller provided. For example, the controller as described is operable to automatically switch connection to the nearest electronic device and the electronic device is operable to continuously play the voice of another speaker, the user thus can freely move around different conference rooms or offices and still be able to continue the call. The controller can thus avoid the dilemma of having to stay in the same conference room, thereby effective enhances the movement flexibility of the user.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A voice transmission system, comprising:
at least one electronic device connected to an internet, comprising:
a first communication module, operative to receive a first voice signal from the internet; and
a speaker unit coupled to the first communication module, operative to play the first voice signal received; and
a controller configured to communicate with the at least one electronic device over a wireless local area network channel and conduct a unidirectional voice transmission, the controller comprising:
a voice receiving unit, configured to receive a second voice signal; and
a second communication module coupled to the voice receiving unit, configured to transmit the second voice signal to the first communication module of the at least one electronic device over the wireless local area network channel;
wherein the first communication module transmits the second voice signal received to the internet.

2. The voice transmission system according to claim 1, wherein the at least one electronic device further comprises:
a decoding unit coupled to the first communication module and the speaker unit, operative to decode the first signal received from the internet and transmit the first signal decoded to the speaker unit.

3. The voice transmission system according to claim 2, wherein the at least one electronic device further comprises:
an image displaying module, configured to output an image signal; and
a first processing unit coupled to the first communication module and the image display module, configured to control the operation of the image displaying module according to an operation instruction received from the controller.

4. The voice transmission system according to claim 3, wherein the at least one electronic device further comprises:
a first memory unit coupled to the first processing unit, storing an identification code corresponding to the at least one electronic device;
wherein the identification code is provided to the controller for identifying the at least one electronic device.

5. The voice transmission system according to claim 1, wherein the controller further comprises
a control unit, configured to generate at least a control signal; and
a second processing unit coupled to the control unit and the second communication module, configured to generate an operation instruction corresponding to the at least one control signal according to a lookup table, and transmit the operation instruction through the first communication module to control the operation of the at least one electronic device thereafter.

6. The voice transmission system according to claim 5, wherein the control unit is configured to control the controller to switch the connection from the at least one electronic device to another electronic device and conduct the unidirectional voice transmission over the wireless local area network channel.

7. The voice transmission system according to claim 5, wherein the controller further comprises:
an encoding unit coupled to the second communication module and the second processing unit, operative to encode the second voice; and
a second memory unit coupled to the second processing unit, storing the lookup table and an identification code corresponding to the at least one electronic device.

8. The voice transmission system according to claim 1, wherein the wireless local area network channel is a wireless fidelity channel or a Bluetooth channel.

9. The voice transmission system according to claim 8, the controller is a remote controller, a presenter, or a wireless mouse.

10. The voice transmission system according to claim 8, wherein the unidirectional voice transmission is conducted using a Bluetooth Low Energy Protocol.

11. The voice transmission system according to claim 1, wherein the at least one electronic device transmits the first voice signal and the second voice signal using a packet format conforming to a Voice-over-IP Protocol.

12. A controller for a voice transmission system, the voice transmission system comprising the controller and as at least one electronic device, the at least one electronic device comprising a first communication module and a speaker unit, the speaker unit operatively playing a first voice signal received by the first communication module from an internet, the controller comprising:
a voice receiving unit, configured to receive a second voice signal; and
a second communication module coupled to the voice receiving unit, configured to transmit the second voice signal to the first communication module of the at least one electronic device over a wireless local area network channel;
wherein the controller conducts a unidirectional voice transmission with the at least one electronic device over the wireless local area network channel, and the first communication module transmits the second voice signal received to the internet.

13. The controller according to claim 12, further comprising:
a control unit, configured to generate at least a control signal; and
a second processing unit coupled to the control unit and the second communication module, configured to generate an operation instruction corresponding to the at least one control signal according to a lookup table, and to transmit the operation instruction generated to control the operation of the at least one electronic device thereafter through the first communication module.

14. The controller according to claim 13, wherein the controller unit is configured to control the controller to switch the connection from the at least one electronic device to another electronic device and conduct the unidirectional voice transmission over the wireless local area network channel.

15. The controller according to claim 14, further comprising:
an encoding unit coupled to the second communication module and the second processing unit, operative to encode the second voice; and
a second memory unit coupled to the second processing unit, storing the lookup table and an identification code corresponding to the at least one electronic device.

16. The controller according to claim 13, wherein the wireless local area network channel is a wireless fidelity channel or a Bluetooth channel.

17. The controller according to claim 16, wherein the controller is a remote controller, a presenter, or a wireless mouse.

18. The controller according to claim 16, wherein the unidirectional voice transmission is conducted using a Bluetooth Low Energy Protocol.
